(19) United States
(12) Patent Application Publication
(10) Pub. No.: US 2019/0133870 A1
(43) Pub. Date: May 9, 2019

(54) Vertical device facilitating full self-serve back massage.

(71) Applicant: Janusz Dudek, Edmonton (CA)

(72) Inventor: Janusz Dudek, Edmonton (CA)

(21) Appl. No.: 15/594,864

(22) Filed: Nov. 6, 2017

(51) Int. Cl. A61H 7/00; A61H 1/00

(52) U.S. Cl. CPC A61H 7/00; A61H 2201/1207; A61H 1/008

(57) ABSTRACT

A simple truth is that a person cannot perform a massage on their own back, let alone exercise any significant pressure, using only their own arms and hands. The achievement and uniqueness of this invention is making available to general public a simple, portable, vertical structure that combines advantages of commercially made professional electric massager (such as Thumper Massager, for example but not limited to) with ease of use that allows for a single person to conveniently perform full value massage of their own back. Such massage would otherwise involve costly services of a chiropractor or massage professional. Major original features of this design are its simple assembly, small footprint once assembled and extreme ease of operation suitable for use by a child or adult of any age. Frequency, duration and intensity of massage are from now on under sole control of the user.

### SPECIFICATION OF THE INVENTION

Back massage is a popular, beneficial and widely used procedure that contributes to well being and health. It usually involves services of professionals such as massage therapists or chiropractors or dedicated members of family or friends. This invention allows a single person to enjoy benefits of full back massage without the help of professionals or testing the level of dedication on part of family or friends. It also eliminates any time limits on duration of the massage and gives a person an option to perform as many back massages per day as they find enjoyable.

The function of the device is as follows: an electric massage device of chosen manufacturer will be inserted into a massager holder frame that will move up and down within a sturdy frame high enough to accommodate an average size person. The up and down movement will be controlled by a person standing in front of the electric massager with their back pressing against the massager, by means of pulling on a line attached to the movable massager holder frame or (optionally), pressing up or down button of an electric motor control unit (wired or wireless) that will elevate or lower the massager holder frame with the massager in it. Duration of massage is up to the user.

Persons taller or significantly taller than average, can sit on a stool in front of the device to operate the device with their back pressing against the massager, just like the standing person would do, and enjoy the same benefits.

### BACKGROUND OF THE INVENTION

Electric hand held massage units exist already in great variety. However, none of them offer a system for a single person to perform full value massage of their own back, by themselves, while standing.

The reason for it is that it is impossible to achieve optimal and comfortable pressure on a desired part of one's back with one's arms behind oneself.

Invention I present eliminates this limitation. It will be very useful, for instance, for those who rely on massage as a medical procedure, or for athletes who enjoy massage after a workout or demanding performance, or seniors who cannot operate heavy, professional massage units. The number of interested user can be very high.

The unit can be equipped with a holder specific to a particular type (manufacturer) of hand held electric massager.

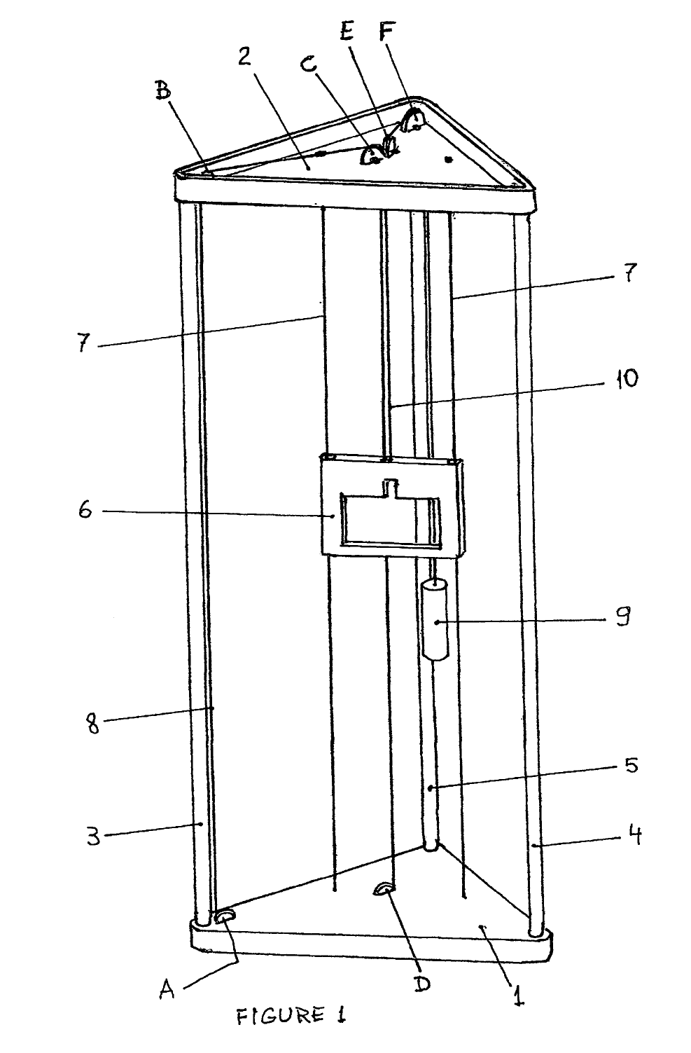

### LEGEND TO FIG. 1

1. Base plate.
2. Top cover.
3. Right side post (as seen by person standing with their back towards massager holder frame.
4. Left side post.
5. Rear post.
6. Massager holder frame.
7. Massager holder frame guiding line.
8. Massager holder frame up and down pull line.
9. Counter balance weight.
10. Counter balance weight line.
A, B, C, D Massager holder frame pull line sheeves.
E, F Counter balance weight line sheeves.

1. This invention allows single person to conveniently perform full value massage of their own back, with no assistance required. Simple system of sheeves and line inside of a sturdy frame (similar in function to a clothing line on sheeves, only arranged vertically instead of horizontally) allows for the commercial electrical massager unit to be pulled upwards by pulling the line downwards, and pulled downwards by pulling the line upwards. A user will press their back against the massager and adjust the vertical location of it at the same time.
Optionally the manual operation can be replaced by electrical motor, operated by means of wired or wireless controls.
